(19) United States
(12) Patent Application Publication
(10) Pub. No.: US 2024/0393932 A1
(43) Pub. Date: Nov. 28, 2024

(54) VISUALIZATION METHODS AND SYSTEMS FOR EVALUATING PERFORMANCE OF A CLASSIFIER AND SELECTION OF OPTIMAL WORKING THRESHOLDS

(71) Applicant: XAI.health, Inc., Rochester, MN (US)

(72) Inventors: Paul A. Friedman, Rochester, MN (US); Itzhak Zachi Attia, Rochester, MN (US)

(21) Appl. No.: 18/440,199

(22) Filed: Feb. 13, 2024

Related U.S. Application Data
(60) Provisional application No. 63/446,103, filed on Feb. 16, 2023.

(51) Int. Cl. G06F 3/04847; G06F 3/04842; G06N 20/00

(52) U.S. Cl. CPC G06F 3/04847; G06F 3/04842; G06N 20/00

(57) ABSTRACT

The present disclosure provides methods and systems for displaying a user interface that presents a classifier statistic, mathematical equation output, or ROC curve on a computing device or mobile phone or tablet. The method comprises: receiving a user's input on said screen using a cursor or pointing element whereby user input comprises selection of a point along a plotted curve, ROC curve, or mathematical function so that input results in displaying one or more figures corresponding to the select statistics or threshold term defined by the user input.

### CROSS-REFERENCE

This application claims the benefit of U.S. Provisional Application No. 63/446,103, filed Feb. 16, 2023, which is entirely incorporated herein by reference.

### BACKGROUND

Machine learning (ML) models have been used in healthcare such as disease diagnosis and detection. In some cases, the predictive models may return a prediction, as well as a confidence score indicating the model's confidence in the prediction (e.g., the probability returned by logistic regression). A confidence score is a number between 0 and 1 that represents the likelihood that the output of a Machine Learning model is correct and will satisfy a user's request (the higher number the more likely the result of the model matching the user's request). However, models may not always produce the correct confidence score (e.g., a prediction of a class with confidence p is not correct 100*p percent of the time.). For example, a mis-calibrated model (due to insufficient training datasets and/or imbalanced training data) may result in confidence scores do not correspond to the probability of an answer being correct. There are methods for calibrating machine learning models (e.g., sigmoid method, isotonic regression, Platt scaling, etc.) which require finding a monotonic function mapping the confidence score to correctness such as by comparing confidence and accuracy on the test sample.

### SUMMARY

Predictive models may return both a prediction and a confidence score indicating the model's confidence in the prediction (e.g., the probability returned by logistic regression). For instance, a probabilistic classifier is a function f: X→[0, 1] that maps each example x to a real number f(x). For a simple classifier, a threshold t may be selected for which the examples where f(x)≥t are considered positive and the others are considered negative (implying that each pair of a probabilistic classifier and threshold t defines a binary classifier). For probabilistic classifiers, the measures are a function of the threshold t. For instance, TP(t) (True positives) which predicts “yes” and correct and FP(t) (False positives) which predicts “yes” and wrong are always monotonic descending functions.

The typical metrics used to measure model performance may include precision, accuracy, recall, or F score. Precision is the ability of a classifier not to label an instance positive that is actually negative. For each class, it is defined as the ratio of true positives to the sum of true and false positives. Recall is the ability of a classifier to find all positive instances. For each class, it is defined as the ratio of true positives to the sum of true positives and false negatives. The F1 score is a weighted harmonic mean of precision and recall such that the best score is 1.0 and the worst is 0.0. Accuracy measures proportion of correct predictions. The accuracy metric may be used when there is no interesting trade-off between a false positive and a false negative prediction. Depending on the type of classifier, the objective and gravity of decisions, different performance metrics may be used. For example, precision and accuracy are often used to measure the classification quality of binary classifiers.

However, models may be mis-calibrated due to insufficient training datasets and/or imbalanced training data. Miscalibration may result in confidence scores do not correspond to the probability of an answer being correct. For model calibration, the conventional way to calibrate a model is by changing the threshold that determines when the model predicts “Yes” or “No.” for instance, making the threshold stricter with class “Yes” and milder with class “No” may balance the proportion.

Model calibration or model performance evaluation often requires learning a monotonic function which maps score to correctness (e.g., comparing confidence and accuracy on the test sample) and a user to find the optimal threshold t based on the monotonic function. For instance, in healthcare field, a graphical plot of a receiver operating characteristic curve, or ROC curve, may be generated to illustrate the diagnostic ability of a binary classifier system as its discrimination threshold is varied. The ROC curve is created by plotting the true positive rate (TPR) against the false positive rate (FPR) at various threshold settings. It is desirable to provide an interactive visualization tool for a user to interact with the ROC graph while being provided with automatically generated relevant classifier parameters, statistical information in a convenient manner.

In some embodiments of the invention herein, a visualization system is provided for interacting with complex statistical outputs such as a Receiver Operating Characteristic (ROC) graph. The visualization system may comprise graphical user interface (GUI) rendering an interactive ROC graph that is capable of receiving user input on the graph and automatically display relevant model performance related information. For example, the interactive ROC graph may comprise a plurality of clickable features. A user may use a user input device such as a mouse or touchpad to select a specific point (clickable features) on the graph. The clickable feature may be activated when the cursor is placed over a point on the graph, allowing the user to access additional information related to that selected point, including but not limited to the sensitivity, specificity, F1 Score, positive predictive value, Negative predictive value, and the classifier output threshold corresponding to the values. In addition to the statistical information, the interaction with the selected threshold (i.e., point selected on the ROC graph) may trigger an update of other classifier parameters and statistical figures as a forest plot, confusion matrix and classifier output histogram, and other pertinent tables and plots. This beneficially provides a visualization tool allowing a user to tune the threshold t for model calibration or for finding the optimal threshold with improved efficiency. In particular, the visualization tool may augment a user's analysis and understanding of the model performance, and bias analysis in an intuitive manner.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an example of GUI providing interactive ROC and relative information.

FIG. 2 shows an example of GUI for equity and bias analysis.

FIG. 3 shows an example of a dynamic graphical plot.

FIGS. 4 and 5 show examples of a backend process for recalculating model parameters upon receiving user input indicative of selection of a group.

FIG. 6 schematically shows a platform in which the method and system herein can be implemented.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Methods and systems of the present disclosure may provide a visualization tool for interacting with complex statistical outputs such as a Receiver Operating Characteristic (ROC) graph. In particular, the backend component of the system may generate interactive visual representation of complex statistical outputs, automatically retrieve relevant information such as model performance metrics, bias analysis calculation, classifier parameters and statistical information in response to a user input and automatically update a visual representation of the respective relevant information.

The visualization tool herein can be integrated into and/or applied to any platforms and applications such as for threshold analysis and equity and bias analysis.

The platform may be capable of efficiently and effectively retrieving and presenting relevant information in real-time in response to a user interaction with the ROC graph or other visual representations in the GUI.

As utilized herein, terms “component,” “system,” “interface,” “unit” and the like are intended to refer to a computer-related entity, hardware, software (e.g., in execution), algorithm, and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In some cases, a component can emulate an electronic component via a virtual machine, e.g., within a cloud computing system.

In some embodiments, methods and systems herein may provide various functions that can be implemented or accessed via web application program interfaces (APIs), a Software Development Kit (SDK), web-based integrated development environment (IDE) and the like. Various components of the system herein may be seamlessly integrated into a third-party platform or system via customized Software Development Kit (SDK) or APIs. For instance, intelligent information extraction and retrieval as well as document processing modules may be provided via open-ended integration with a full suite of APIs and plugins thereby allowing for convenient and seamless system integrations into any third-party systems.

In some cases, the visualization methods and systems may be implemented on a cloud platform system (e.g., including a server or serverless) that is in communication with one or more user systems/devices via a network. The cloud platform system may be configured to provide the aforementioned functionalities to the users via one or more user interface. The user interface may comprise a graphical user interfaces (GUIs), which may include, without limitation, web-based GUIs, client-side GUIs, or any other GUI as described above.

A graphical user interface (GUI) is a type of interface that allows users to interact with electronic devices through graphical icons and visual indicators such as secondary notation, as opposed to text-based interfaces, typed command labels or text navigation. The actions in a GUI are usually performed through direct manipulation of the graphical elements. In addition to computers, GUIs can be rendered in hand-held devices such as mobile devices, MP3 players, portable media players, gaming devices and smaller household, office and industry equipment. The GUIs may be provided in a software, a software application, a web browser, etc. The GUIs may be displayed on a user device or user system (e.g., mobile device, personal computers, personal digital assistants, cloud computing system, etc.). The GUIs may be provided through a mobile application or web application.

In some cases, the graphical user interface (GUI) or user interface may be provided on a display. The display may or may not be a touchscreen. The display may be a light-emitting diode (LED) screen, organic light-emitting diode (OLED) screen, liquid crystal display (LCD) screen, plasma screen, or any other type of screen.

In some cases, one or more systems or components of the system (e.g., frontend component, backend component) may be implemented as a containerized application (e.g., application container or service containers). The application container may provide tooling for applications and batch processing, such as web servers with Python or Ruby, JVMs, or even Hadoop or HPC tooling. For instance, the frontend of the system may be implemented as a web application using the framework (e.g., Django Python) hosted on an Elastic Cloud Compute (EC2) instance on Amazon Web Services (AWS). The backend of the system may be implemented as serverless compute service such as hosted on AWS Lambda as a serverless compute service running a web framework for developing RESTful APIs (e.g., FastAPI). This may beneficially allow for a large-scale implementation of the system. In some cases, the backend system (e.g., AWS Lambda) may partition a separate (e.g., 10 GB RAM) compute service for each independent analysis and/or session, allowing for a large number of concurrent analyses.

In some cases, one or more functions or operations consist with the methods described herein can be provided as software application that can be deployed as a cloud service, such as in a web services model. A cloud-computing resource may be a physical or virtual computing resource (e.g., virtual machine). In some embodiments, the cloud-computing resource is a storage resource (e.g., Storage Area Network (SAN), Network File System (NFS), or Amazon S3®), a network resource (e.g., firewall, load-balancer, or proxy server), an internal private resource, an external private resource, a secure public resource, an infrastructure-as-a-service (IaaS) resource, a platform-as-a-service (PaaS) resource, or a software-as-a-service (SaaS) resource. Hence, in some embodiments, a cloud-computing service provided may comprise an IaaS, PaaS, or SaaS provided by private or commercial (e.g., public) cloud service providers.

It should be noted that methods and systems of the present disclosure may utilize any type of machine learning algorithms, architectures or approaches. The machine learning algorithm may comprise one or more of the following: a support vector machine (SVM), a naïve Bayes classification, a linear regression, a quantile regression, a logistic regression, a random forest, a neural network, convolutional neural network (CNN), recurrent neural network (RNN), a gradient-boosted classifier or regressor, or another supervised or unsupervised machine learning algorithm (e.g., generative adversarial network (GAN), Cycle-GAN, etc.).

The present disclosure provides a visualization tool that is capable of providing improved flexibility for a user to provide input via a user interface (UI) to specify any interested parameters (e.g., model's sensitivity (SN), specificity (SP), Positive predictive value (PPV), Negative predictive value (NPV), F1 Score, and prevalence, etc.) in an interactive manner and other relevant information may be automatically updated and displayed on the UI. Although the visualization systems and methods are described in the context of healthcare and diagnosis analysis, it should be noted that the method can be applied to classify any predictions in various applications without limitation.

In some embodiments, the machine learning (ML) model may be a binary classifier trained using any suitable machine learning algorithm. The machine learning algorithm may comprise one or more of the following: a support vector machine (SVM), a naïve Bayes classification, a linear regression model, a quantile regression model, a logistic regression model, a random forest, decision tree, k-Nearest Neighbors, and the like.

In some embodiments, the ML model may be developed using cross-validation dataset. For example, during a k-fold cross-validation (k=2, 3, 4, 5, 6, etc.) for evaluating a predictive model, the training data set for the predictive model may be split into k smaller sets. The predictive model is trained using k−1 of the folds as training data; the resulting predictive model is validated on the remaining part of the data (i.e., testing holdout dataset). For instance, the remaining part of the data may be used as a test/validation set to compute the performance metrics (e.g., accuracy, recall, precision, F score, etc.) for evaluating the predictive model. In some cases, the ROC graph is generated using the holdout dataset.

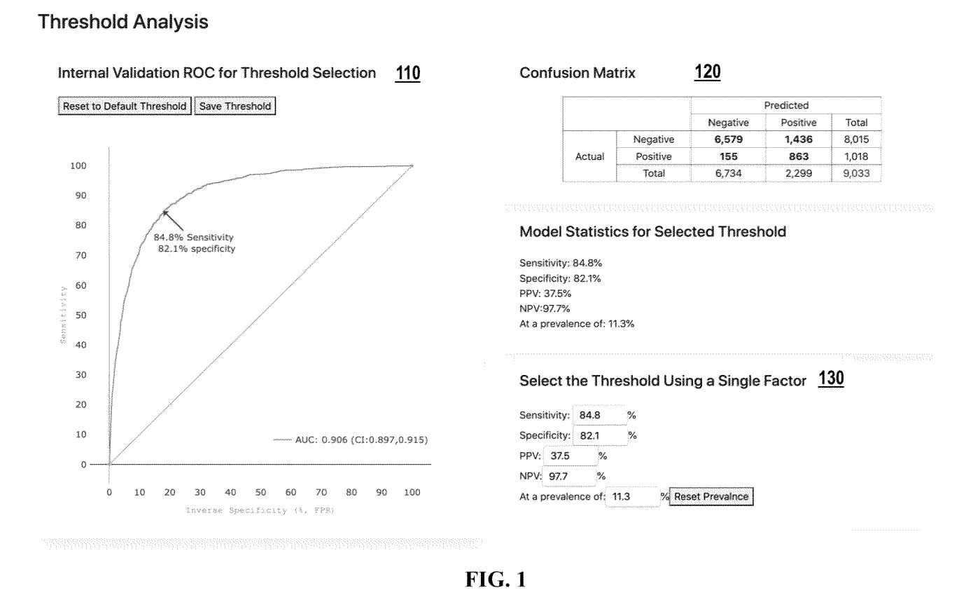

FIG. 1 shows an example of GUI providing interactive ROC and relative information. As shown in the example, the interactive ROC provides a graphical representation of a classifier's performance across a variety of thresholds.

In the illustrated example, the GUI may display a first panel including a ROC interactive curve (e.g., plots values of true positive rates (y-axis) against those of false positive rates (x-axis) and these values are plotted at various probability thresholds). A user may select any point on the ROC such as by placing the cursor at a point of interest, and as the cursor changes its (x, y) coordinates on the ROC graph, the corresponding sensitivity and specificity value may be updated and displayed accordingly. The selectable or clickable points on the ROC curve may be discrete based on computing data points. Alternatively, the selectable or clickable points on the ROC curve may be continuous and may include interpolating points.

A user may be permitted to identify and select a point by clicking on the point of ROC and save it as a threshold of interest. A user may select any point on the ROC and the relevant information may be updated automatically. For example, the relevant information may be presented in any type of graph including but not limited to line graphs, bar graphs, pie charts, forest plots and other means of displaying data, graphically or in tabular form. The relevant information may comprise, but not limited to, confusion matrix, model statistics (e.g., model's sensitivity (SN), specificity (SP), Positive predictive value (PPV), Negative predictive value (NPV), F1 Score, and prevalence, etc.) for the selected threshold.

In some cases, a user input received on the ROC or within the first panel 110 may trigger a retrieval of the relevant information and an update of detailed information such as statistical measures such as sensitivity, specificity, F1 Score, positive and negative predictive values, and the classifier output threshold corresponding to these values.

The GUI may then dynamically update the presentation of the relevant information such as the related classifier parameters and statistical representations, such as a forest plot, confusion matrix, and classifier output histogram. In some cases, the GUI may permit users to set up or specify the visual display of the relevant information. For example, a user may be allowed to change the arrangement or display of the confusion matrix, model statistics in the second panel 120, or change a presentation format of the parameters (e.g., selection of table, pie chart, etc.).

The GUI may also comprise a third panel 130 allowing a user to provide input for one or more of the classifier statistical parameters. For example, a user may change or specify classifier statistical parameters, as but not limited to sensitivity, specificity, F1 Score, positive predictive value, negative predictive value, and the classifier output threshold, via input text field in the third panel 130. The user can change by typing, or selecting from a pre-populated set of options, new values for each of the fields. Upon receiving a user input indicating a value in one of the field for a model statistic metric, values of other fields and a classifier threshold output will be automatically retrieved and/or calculated to accommodate the selected model statistic metric. The action will also trigger recalculation of other model statistics and the value of other model statics may be updated automatically on the GUI. As an example, a user may input any values in a selected field (e.g., sensitivity of 90%), and the threshold may be automatically adjusted to accommodate the input value (e.g., backend looks up the threshold that yields the sensitivity), while values of other fields may be updated to show their value for the given input (e.g., values for SP, PPV, NPV and F1 that correspond to the sensitivity value is updated for display).

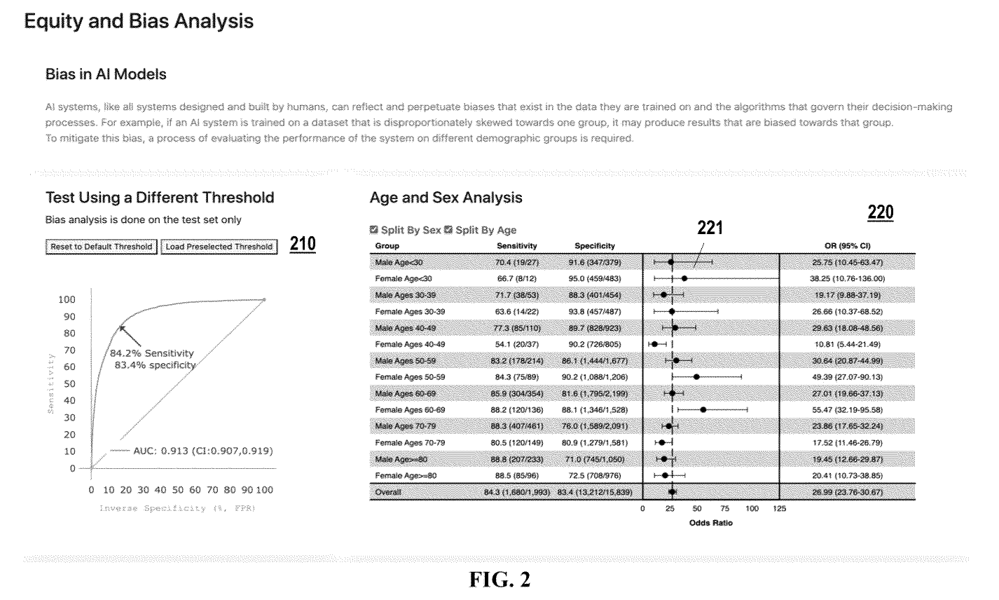

FIG. 2 shows an example of GUI for equity and bias analysis. AI systems may reflect and perpetuate biases that exist in the data they are trained on and the algorithms that govern their decision-making processes. For example, if an AI system is trained on a dataset that is disproportionately skewed towards one group, it may produce results that are biased towards that group. The dynamic and interactive display of the ROC and group data may beneficially improve the process of evaluating the performance of the AI model on different demographic groups.

The GUI may similarly comprise a first panel 210 providing an interactive ROC graph. A user may access detailed information and provide an input indicating selection of a threshold by interacting with the ROC graph as described above.

In some cases, a user input provided via the ROC graph may trigger a dynamic output in a second panel 220 of the GUI. The GUI may comprise a second panel 220 displaying a plurality of demographic groups and their respective model performance parameters for bias analysis. For example, the bias analysis may be performed by a user filtering or grouping the classifier data by sex and/or age. As an example, a user may select one or more groups via the second panel, and the ROC graph may be automatically calculated and updated using the data corresponding to the selected one or more group data. A user may select which demographics and fields to analyze, including but not limited to, age/age group, sex, race, presence of diabetes or a combination of any of the selections (e.g., M with age<50, F age <50, etc.). The second panel may also show the same parameters for the whole cohort without grouping.

A user may interact with the ROC to select a threshold which may trigger an update and/or recalculation of other model parameters and relevant information as described above. For example, a user may select a new threshold by clicking on the ROC, and upon receiving the new threshold, the forest plot showing the Likelihood ratio, AUC, SN, SP, etc, and confidence intervals(CI) (90%, 95%, 99% . . . ) for all selected demographics may updated.

In some cases, the GUI may provide a dynamic output. The dynamic output may include, for example, an animated graph or plot demonstrating a change in a plot that graphically illustrates the impact of or magnitude of the changes. The dynamic output or animated graphs may show a change or transition from the original of the graph to the destination of the graph. The dynamic output may present the change and/or the magnitude of the change in various different methods such as by changing color, line width or other dynamic modification that visually depicts the magnitude and or direction of a change in the graphical representation.

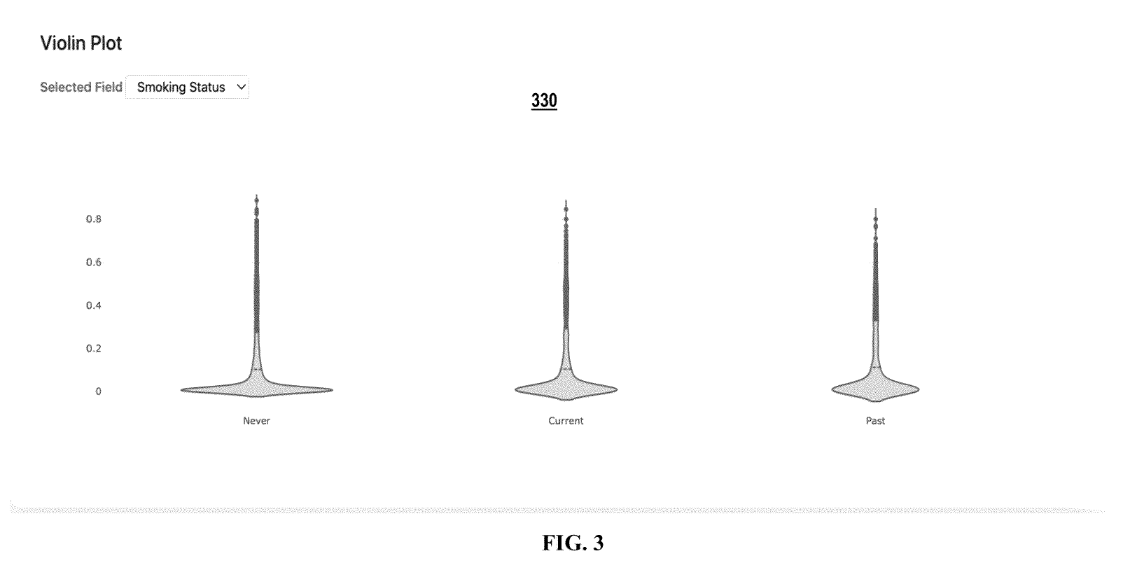

FIG. 2 and FIG. 3 shows examples of dynamic graphical plot such as Forrest plot 221 and violin plot 330. As described above, the dynamic graphic representation or graph may show a change in the graph that illustrating the impact of or magnitude of the changes in response to a user provided input.

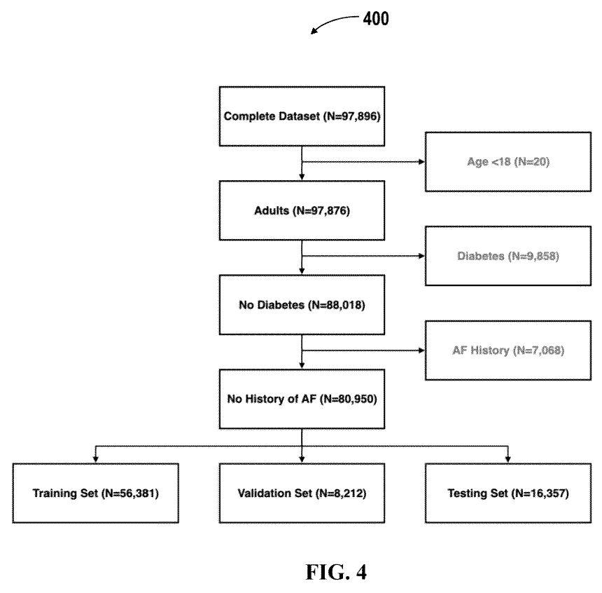

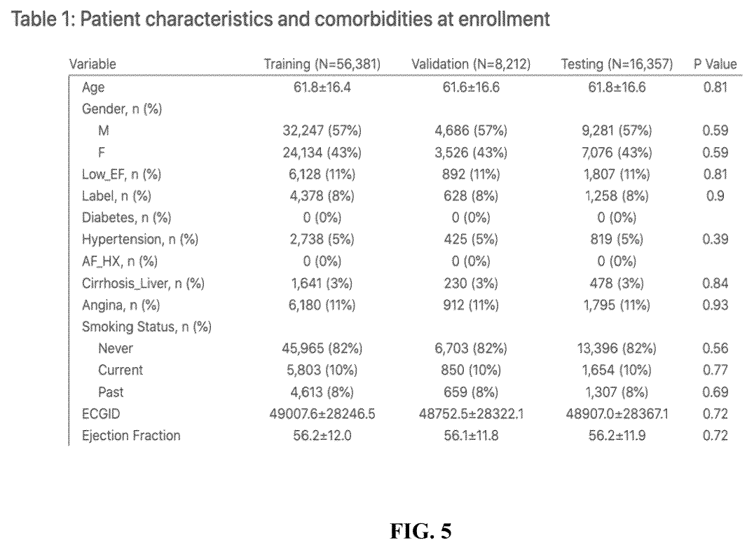

FIGS. 4-5 show examples of a backend process for recalculating model parameters upon receiving user input indicative of selection of a group. The selection of group may be translated to filtering of classifier data to use only the data of the selected group to calculate the corresponding ROC and other relevant model parameters and the like. The recalculated data may then be used to update the visual representation for display on the GUI.

The visual representation of the bias analysis may allow users to visualize bias in the mathematical model, the ML model or the AI system. For example, based on the model parameters, performance metrices calculated for all or selected groups, if certain groups have a value that is below the lower CI of the overall cohort, or if there are any non-overlapping CI between groups, the system may generate alert indicative of detection of bias. In some cases, the system may generate a score measuring the average overlap among groups. For example, a perfect overlap means 0% bias as the model is working exactly the same on all of them, whereas a no overlap means 100% bias.

In some cases, upon detection of the biases, the ML model may be retrained with matching of the biased factor. For instance, if the model performance is different for men and women groups (e.g., lower degree of overlap), the system may output a message suggesting retraining but keeping the exact same number of men and women in both the control and the cases. Depending on the detected bias and the ML model being used, the system may generate various recommendations such as when generative models (V-GAN) are utilized, the system may generate recommendation for the user to synthetically create data in categories with few samples (e.g., creating more positive women samples from the man positive training samples).

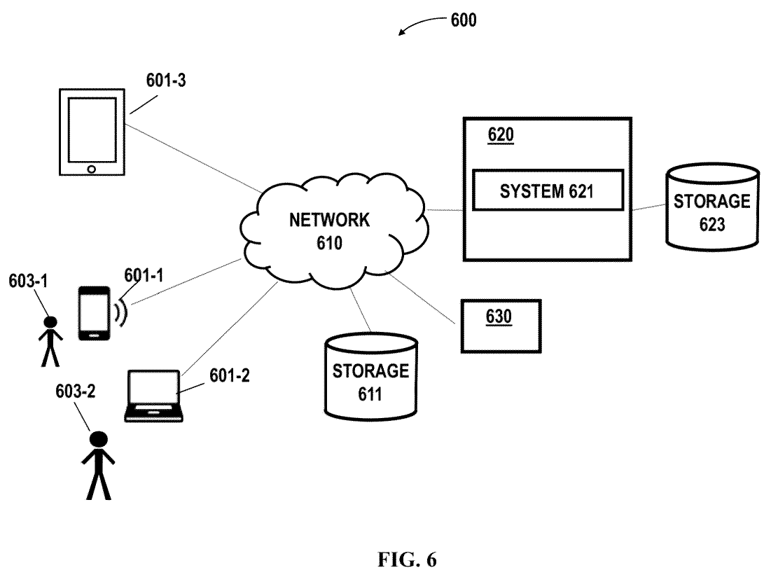

FIG. 6 schematically shows a platform 600 in which the visualization method and system herein can be implemented. A platform 600 may include one or more user devices 601-1, 601-2, 601-3, a server 620, a system 621, one or more third-party systems 630, and a storage unit 611, 623. Each of the components 601-1, 601-2, 601-3, 611, 620, 621, 623, 630 may be operatively connected to one another via a network 610 or any type of communication link that allows transmission of data from one component to another.

The system 621 may be configured to permit users to perform bias analysis and threshold analysis using the visualization methods as described herein. The system 621 may include a plurality of functional components such as ML model, user interface module, dynamic output generator, model creation and management system, and/or various others described elsewhere herein.

In some cases, the system 621 may be configured to train, develop and retrain a plurality of predictive models (e.g., classifiers, RNN, CNN, GAN, etc.). The system 621 may train and develop a confidence model as described above. The system 621 may implement the backend processes and methods herein to automatically recalculate or retrieve relevant model performance parameters, detailed information in real-time in response to receiving a user input provided via the frontend. The system 621 may comprise a dynamic output generator to generate a dynamic graph demonstrating impact of or magnitude of the changes in response to a user input. The system 621 may be configured to perform one or more operations and provide one or more features consistent with those described elsewhere herein.

In some embodiments, the system may be implemented in a cloud-based platform. For example, the front-end of the system may be implemented as a web application using the framework (e.g., Django Python) hosted on an Elastic Cloud Compute (EC2) instance on Amazon Web Services (AWS). The backend of the system may be implemented as serverless compute service such as hosted on AWS Lambda as a serverless compute service running a web framework for developing RESTful APIs (e.g., FastAPI). This may beneficially allow for a large scale implementation of the system. For instance, the backend system (e.g., AWS Lambda) may partition a separate (e.g., 10 GB RAM) compute service for each independent cohort data submission, allowing for a large number of concurrent analyses.

The system 621 may be implemented anywhere within the platform, and/or outside of the platform 600. In some embodiments, system 621 may be implemented on server 620. In other embodiments, a portion of the system 621 may be implemented on the user device. Additionally, a portion of system 621 may be implemented on the third-party system 630. Alternatively or in addition to, a portion of the system 621 may be implemented in one or more storage units (e.g., data lakes, databases) 611, 623. The system 621 may be implemented using software, hardware, or a combination of software and hardware in one or more of the above-mentioned components within the platform.

In some embodiments, a user 603-1, 603-2 may be associated with one or more user devices 601-1, 601-2, 601-3. User device 601-1, 601-2, 601-3 may be a computing device configured to perform one or more operations consistent with the disclosed embodiments. Examples of user devices may include, but are not limited to, laptop or notebook computers, desktop computers, mobile devices, smartphones/cell phones, wearable device (e.g., smartwatches), tablets, personal digital assistants (PDAs), media content players, television sets, video gaming station/system, virtual reality systems, augmented reality systems, microphones, or any electronic device capable of analyzing, receiving (e.g., receiving user input indicating selection of threshold on ROC, model parameter value, selection of a demographic group, etc.), providing or displaying certain types of data (e.g., rendering of a GUI displaying the interactive ROC, relevant graphs and model parameters, dynamic output, etc.) to a user. The user device may be portable. In some cases, the user device may be located remotely from a human user, and the user can control the user device using wireless and/or wired communications. The user device can be any electronic device with a display.

User device 601-1, 601-2, 601-3 may include one or more processors that are capable of executing non-transitory computer readable media that may provide instructions for one or more operations consistent with the disclosed embodiments. The user device may include one or more memory storage devices comprising non-transitory computer readable media including code, logic, or instructions for performing the one or more operations. For example, when the application is about information extraction or retrieval, the user device may include software applications that allow the user to search or query information in one or more documents (e.g., software application provided by third-party server 630), and/or software applications provided by the system 621 that allow the user device to communicate with and transfer data between server 620, the system 621, and/or the storage unit (e.g., knowledge base or database 611).

The user device 601-1, 601-2, 601-3 may include a communication unit, which may permit the communications with one or more other components in the platform 600. In some instances, the communication unit may include a single communication module, or multiple communication modules. In some instances, the user device may be capable of interacting with one or more components in the platform 600 using a single communication link or multiple different types of communication links.

User devices 601-1, 601-2, 601-3 may include a display. The display may be a screen. The display may or may not be a touchscreen. The display may be a light-emitting diode (LED) screen, OLED screen, liquid crystal display (LCD) screen, plasma screen, or any other type of screen. The display may be configured to show a user interface (UI) or a graphical user interface (GUI) rendered through an application (e.g., via an application programming interface (API) executed on the user device). The GUI may display, for example, the portal for threshold analysis and bias analysis as described above. The user device may also be configured to display webpages and/or websites on the Internet. One or more of the web pages/websites may be hosted by server 620, the third-party system 630 and/or rendered by the system 621.

In some cases, users may utilize the user devices to interact with the system 621 or the third-party system 630 by way of one or more software applications (i.e., client software) running on and/or accessed by the user devices, wherein the user devices and the system 621 or the third-party system 630 may form a client-server relationship. For example, the user devices may run dedicated mobile applications or software applications for accessing the client portal provided by the system 621 or the third-party system 630.

In some cases, the client software (i.e., software applications installed on the user devices 601-1, 601-2, 601-3) may be available either as downloadable software or mobile applications for various types of computer devices. Alternatively, the client software can be implemented in a combination of one or more programming languages and markup languages for execution by various web browsers. For example, the client software can be executed in web browsers that support JavaScript and HTML rendering, such as Chrome, Mozilla Firefox, Internet Explorer, Safari, and any other compatible web browsers. The various embodiments of client software applications may be compiled for various devices, across multiple platforms, and may be optimized for their respective native platforms.

In some cases, the provided system may provide one or more graphical user interfaces (GUIs). The GUIs may be rendered on a display screen on a user device 601-1, 601-2, 601-3. A GUI is a type of interface that allows users to interact with electronic devices through graphical icons and visual indicators such as secondary notation, as opposed to text-based interfaces, typed command labels or text navigation. The actions in a GUI are usually performed through direct manipulation of the graphical elements. In addition to computers, GUIs can be found in hand-held devices such as MP3 players, portable media players, gaming devices and smaller household, office and industry equipment. The GUIs may be provided in software, a software application, a mobile application, a web browser, or the like. The GUIs may be displayed on a user device (e.g., desktop computers, laptops or notebook computers, mobile devices, smart phones, personal digital assistants (PDAs), and tablets).

A server 620 may access and execute the system 621 to perform one or more processes consistent with the disclosed embodiments. In certain configurations, the system may be software stored in memory accessible by a server (e.g., in memory local to the server or remote memory accessible over a communication link, such as the network). Thus, in certain aspects, the system(s) may be implemented as one or more computers, as software stored on a memory device accessible by the server, or a combination thereof.

In some embodiments, one or more systems or components of the present disclosure are implemented as a containerized application (e.g., application container or service containers). The application container provides tooling for applications and batch processing such as web servers with Python or Ruby, JVMs, or Hadoop or HPC tooling. The various functions performed by the system such as the ML model, generating dynamic representation of complex analysis result and interactive graphs and the like may be implemented in software, hardware, firmware, embedded hardware, standalone hardware, application specific-hardware, or any combination of these. The system, and techniques described herein may be realized in digital electronic circuitry, integrated circuitry, specially designed ASICs (application specific integrated circuits), computer hardware, firmware, software, and/or combinations thereof. These systems, devices, and techniques may include implementation in one or more computer programs that are executable and/or interpretable on a programmable system including at least one programmable processor, which may be special or general purpose, graphics processing unit (GPU), coupled to receive data and instructions from, and to transmit data and instructions to, a storage system, at least one input device, and at least one output device. These computer programs (also known as programs, software, software applications, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, and/or device (such as magnetic discs, optical disks, memory, or Programmable Logic Devices (PLDs)) used to provide machine instructions and/or data to a programmable processor.

The third-party system 630 can be any existing platforms or systems that provide model training, development, external data sources, and the like.

A server may include a web server, an enterprise server, or any other type of computer server, and can be computer programmed to accept requests (e.g., HTTP, or other protocols that can initiate data transmission) from a computing device (e.g., user device) and to serve the computing device with requested data. In addition, a server can be a broadcasting facility, such as free-to-air, cable, satellite, and other broadcasting facility, for distributing data. A server may also be a server in a data network (e.g., a cloud computing network).

A server may include known computing components, such as one or more processors, one or more memory devices storing software instructions executed by the processor(s), and data. A server can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers.

Network 610 may be a network that is configured to provide communication between the various components illustrated in FIG. 6. The network may be implemented, in some embodiments, as one or more networks that connect devices and/or components in the network layout for allowing communication between them. For example, user device 601-1, 601-2, 601-3 third-party system 630, server 620, system 621, and storage units 611, 623 may be in operable communication with one another over network 610. Direct communications may be provided between two or more of the above components. The direct communications may occur without requiring any intermediary device or network. Indirect communications may be provided between two or more of the above components. The indirect communications may occur with aid of one or more intermediary devices or networks. For instance, indirect communications may utilize a telecommunications network. Indirect communications may be performed with aid of one or more routers, communication towers, satellites, or any other intermediary device or network. Examples of types of communications may include, but are not limited to: communications via the Internet, Local Area Networks (LANs), Wide Area Networks (WANs), Bluetooth, Near Field Communication (NFC) technologies, networks based on mobile data protocols such as General Packet Radio Services (GPRS), GSM, Enhanced Data GSM Environment (EDGE), 3G, 4G, 5G or Long Term Evolution (LTE) protocols, Infra-Red (IR) communication technologies, and/or Wi-Fi, and may be wireless, wired, or a combination thereof. In some embodiments, the network may be implemented using cell and/or pager networks, satellite, licensed radio, or a combination of licensed and unlicensed radio. The network may be wireless, wired, or a combination thereof.

User device 601-1, 601-2, 601-3, third-party system 630, server 620, or system 621, may be connected or interconnected to one or more storage units (e.g., databases) 611, 623. The databases may be one or more memory devices configured to store structured data. Additionally, the databases may also, in some embodiments, be implemented as a computer system with a storage device. In one aspect, the databases may be used by components of the network layout to perform one or more operations consistent with the disclosed embodiments. One or more local databases, and cloud databases of the platform may utilize any suitable database techniques. For instance, structured query language (SQL) or “NoSQL” database may be utilized for storing the model parameters, bias analysis result, user selected optimal threshold, performance metrics, classifier data, training datasets (e.g., correctness measures, scores) and the like. Some of the databases may be implemented using various standard data-structures, such as an array, hash, (linked) list, struct, structured text file (e.g., XML), table, JavaScript Object Notation (JSON), NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. In some embodiments, the database may include a graph database that uses graph structures for semantic queries with nodes, edges and properties to represent and store data. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

Although particular computing devices are illustrated and networks described, it is to be appreciated and understood that other computing devices and networks can be utilized without departing from the spirit and scope of the embodiments described herein. In addition, one or more components of the network layout may be interconnected in a variety of ways, and may in some embodiments be directly connected to, co-located with, or remote from one another, as one of ordinary skill will appreciate.

Various aspects of the present disclosure may be applied to any of the particular applications set forth below or for any other types of applications or systems. Systems or methods of the present disclosure may be employed in a standalone manner, or as part of a package. The system may also allow for an easy and flexible integration of the various visualization features into any existing third-party website or platforms. For instance, the system may provide a plurality of options such as raw application programming interface (API), Plugins, SDK, Google Tag Manager and the like for integrating the AI-based outputs (e.g., threshold analysis, bias analysis, etc.) to a third-party platform. For example, the system may create various API endpoints for rendering frontend elements and code injection. For instance, the system may include a family of plugins, extensions, modules and scripts that facilitate development and integration of the interactive ROC, dynamic output, bias analysis, threshold analysis, and other features into third-party platforms.

Aspects of the systems and methods provided herein can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for displaying a user interface that presents a classifier statistic, mathematical equation output, or ROC curve on a computing device or mobile phone or tablet, comprising: receiving a user's input on said screen using a cursor or pointing element whereby user input comprises selection of a point along a plotted curve, ROC curve, or mathematical function so that input results in displaying one or more figures corresponding to the select statistics or threshold term defined by the user input.

2. The method of claim 1, wherein said user input comprises a text entry including a predefined statistic.

3. The method of claim 2, wherein selecting an input by any means leads to creation of or changes to a confusion matrix, model statistics, and/or threshold selections.

4. The method of claim 1, wherein selecting an input leads to changes in a graphical plot such as a Forrest plot or violin plot.

5. The method of claim 1, wherein changing a selected input leads to a video demonstrating the change in a plot that graphically illustrates the impact of or magnitude of the changes by showing original and destination plots or outputs.

6. The method of claim 5, whereby changing a selected input leads to a video demonstrating the change in a graphical plot to illustrate the magnitude of the change by other means such as changing color, line width or other dynamic modification that visually depicts the magnitude and or direction of a change.

7. The method of claim 1, wherein the dynamic outputs depict bias in a mathematical model.

8. The method of claim 1, wherein the dynamic outputs depict bias in an AI model or system.

9. The method of claim 1, wherein the dynamic outputs depict sex or age bias in an AI model or system, or in a mathematical model.
